(19) United States
(12) Patent Application Publication
(10) Pub. No.: US 2007/0153017 A1
(43) Pub. Date: Jul. 5, 2007

(54) Semantics-guided non-photorealistic rendering of images

(75) Inventors: Kentaro Toyama, Redmond, WA (US); Neeharika Adabala, Bangalore (IN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/325,250

(22) Filed: Jan. 3, 2006

(51) Int. Cl. G09G 5/00

(52) U.S. Cl. 345/582

(57) ABSTRACT

A facility for semantics-guided non-photorealistic rendering is described. In various embodiments, the facility receives a set of objects that are to be rendered in a non-photorealistic manner. For each received object, the facility determines whether the object has an associated indication of a feature type and, when the object has an associated indication of a feature type, employs a transformation function corresponding to the indicated feature type to render the object in a non-photorealistic style provided by the transformation function.

### BACKGROUND

Users sometimes employ computers to generate or “render” computer graphics (“images”) that range between photorealism and non-photorealism. Photorealistic images provide accurate visual depictions of objects—whether real or not—whereas non-photorealistic images appear to be hand drawn or are otherwise fanciful or artistic. Most maps are types of images that are generally two-dimensional, geometrically accurate representations of a three-dimensional space. Aerial images could be construed as a kind of map, and a graphics system that generates imagery that looks like them would be considered a photorealistic aerial image synthesizer. Most maps are geometrically accurate yet visually simplified. Such maps provide visual representations of information assembled by cartographers to meaningfully and accurately depict the three-dimensional space in two dimensions. Maps may depict various features of the three-dimensional space, such as roads, water bodies, and buildings. Finally, non-photorealistic maps can be more stylized and may use non-literal symbolism. As an example, non-photorealistic maps with whimsical or artistic renderings of map features are sometimes provided to tourists by tour operators. These maps may not be to scale and may depict features artistically. Maps, like other images, can thus span the range between photorealistic and non-photorealistic.

Various techniques exist for creating non-photorealistic images using computers. These techniques generally render objects based on geometric parameters that define the objects being rendered. As an example, these techniques may determine that a line appearing between a large water body and a landmass defines a coastline. When a rendering algorithm encounters such a coastline, it may render the coastline in a darker shade than other lines appearing in the map. However, when a line defining a mountain range appears between a water body and a landmass, such a rendering algorithm may not correctly depict the mountain range and may incorrectly depict the line as a coastline. Furthermore, the rendering algorithm may not employ a suitable algorithm for rendering a feature artistically that is based on input other than an object's geometric parameters.

### SUMMARY

A facility is described for synthesizing images in the various ways during non-photorealistic rendering of vector representations of image features, such that the features in the image are drawn differently based on semantic labels attached to data that defines the features. In various embodiments, the facility utilizes transformation and rendering algorithms to generate non-photorealistic images in which features are transformed or rendered based on associated “labels” indicated in inputs corresponding to the features, such as inputs in a data file. A label indicates the type of object, such as a map's feature. As an example, whereas a line or a spline may provide the geometric characteristics of a street, river, or other linear feature of a map, an associated label can indicate that the feature is in fact a street or a river. When the feature is so labeled, the facility utilizes a transformation or rendering algorithm appropriate for the label. Thus, the facility is able to generate semantically guided non-photorealistic images, such as maps containing artistic effects, by considering labels associated with objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example of a suitable computing environment in which aspects of the facility may be implemented.

FIG. 2 is a block diagram illustrating aspects of the facility in various embodiments.

FIG. 3 is a flow diagram illustrating a draw-objects routine executed by the facility in various embodiments.

FIG. 4 is a flow diagram illustrating a render-object routine executed by the facility in various embodiments.

FIG. 5A is a display diagram illustrating an example of a line defined by control points.

FIGS. 5B-5D are display diagrams illustrating potential map features and rendering styles corresponding to the line of FIG. 5A.

### DETAILED DESCRIPTION ___

A facility is described for synthesizing semantically-guided, non-photorealistic images of vector representations of image features. In various embodiments, the facility utilizes transformation and rendering algorithms to generate non-photorealistic images in which features are transformed or rendered based on associated “labels” indicated in inputs corresponding to the features. A label indicates the type of object, such as a map's feature. As an example, whereas a line or a spline may provide the geometric characteristics of a street, river, or other linear feature of a map, an associated label can indicate that the feature is a street or a river. When the feature is so labeled, the facility utilizes a transformation or rendering algorithm appropriate for the label. As an example, when a label of a data file identifies a line as a street, the facility may use a transformation algorithm applicable to streets. In contrast, when the label identifies the line as a river, the facility may use a transformation algorithm applicable to rivers. This is known as “semantics-guided transformation.” These transformation algorithms may also render the features by simultaneously applying an artistic effect. As an example, the transformation algorithms may render objects in a woodcut-like manner. Thus, the facility is able to generate semantics-guided non-photorealistic images, such as maps containing artistic effects, by considering labels associated with objects.

In various embodiments, the facility may receive indications of various options, such as a style for transformations. Examples of styles include, but are not limited to, woodcuts, animations, town plans, etc. The facility renders transformed images according to these options. The facility then combines the rendered features into an image. As an example, the facility may use matting or overlaying techniques to combine the rendered features. In various embodiments, the facility uses procedural techniques with stochastic elements to render features. In some embodiments, such procedural techniques can specify a feature algorithmically, e.g., instead of providing a bitmap. In various embodiments, the facility may also use bitmaps or other graphics techniques. The facility can use stochastic techniques to introduce a randomness factor when rendering an image.

In various embodiments, the facility receives as input a vector representation of an image, such as a map. The vector representation indicates geometric objects with corresponding labels. Each geometric object defines a feature, such as a tree, house, street, river, mountains, lake, etc. The features can be defined by geometric shapes such as points, lines, splines, polygons, areas, volumes, etc. The facility processes this input to create an image.

The facility thus enables rendering of images with artistic or other useful features, such as by employing vector features that are labeled with semantics-related information.

As used herein, transformation means converting a set of inputs, such as a definition of objects in a data file, into a representation that can be rendered on a screen. Transformation further includes geometrically or otherwise manipulating the representation, such as to add an artistic effect.

### Illustrated Embodiments

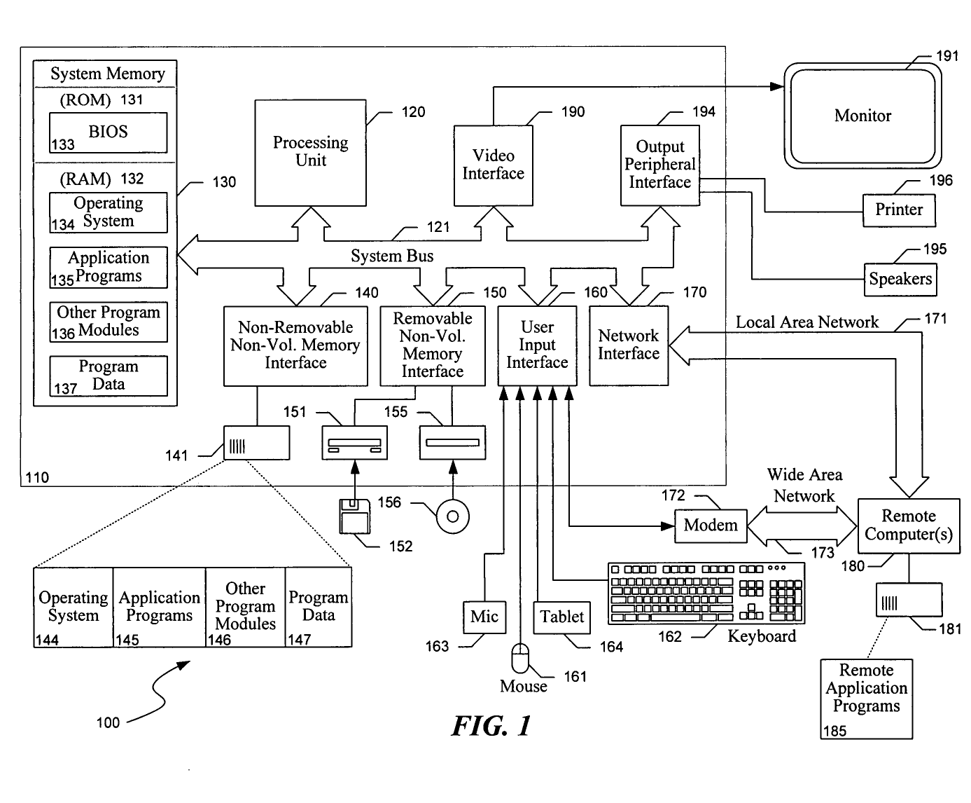

Turning now to the figures, FIG. 1 is a block diagram illustrating an example of a suitable computing system environment 110 or operating environment in which the techniques or facility may be implemented. The computing system environment 110 is only one example of a suitable computing environment and is not intended to suggest any limitation as to the scope of use or functionality of the facility. Neither should the computing system environment 110 be interpreted as having any dependency or requirement relating to any one or a combination of components illustrated in the exemplary operating environment 110.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The facility may be described in the general context of computer-executable instructions, such as program modules, being executed by a computer. Generally, program modules include routines, programs, objects, components, data structures, and so forth that perform particular tasks or implement particular abstract data types. The facility may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the facility includes a general purpose computing device in the form of a computer 111. Components of the computer 111 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as a Mezzanine bus.

The computer 111 typically includes a variety of computer-readable media. Computer-readable media can be any available media that can be accessed by the computer 111 and include both volatile and nonvolatile media and removable and nonremovable media. By way of example, and not limitation, computer-readable media may comprise computer storage media and communications media. Computer storage media include volatile and nonvolatile and removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 111. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network or direct-wired connection, and wireless media, such as acoustic, RF, infrared, and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within the computer 111, such as during start-up, is typically stored in ROM 131. RAM 132 typically contains data and/or program modules that are immediately accessible to and/or presently being operated on by the processing unit 120. By way of example, and not limitation, FIG. 1 illustrates an operating system 134, application programs 135, other program modules 136, and program data 137.

The computer 111 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a nonremovable memory interface, such as an interface 140, and the magnetic disk drive 151 and optical disk drive 155 are typically connected to the system bus 121 by a removable memory interface, such as an interface 150.

The drives and their associated computer storage media, discussed above and illustrated in FIG. 1, provide storage of computer-readable instructions, data structures, program modules, and other data for the computer 111. In FIG. 1, for example, the hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers herein to illustrate that, at a minimum, they are different copies. A user may enter commands and information into the computer 111 through input devices such as a tablet or electronic digitizer 164, a microphone 163, a keyboard 162, and a pointing device 161, commonly referred to as a mouse, trackball, or touch pad. Other input devices not shown in FIG. 1 may include a joystick, game pad, satellite dish, scanner, or the like. These and other input devices are often connected to the processing unit 120 through a user input interface 160 that is coupled to the system bus 121, but may be connected by other interface and bus structures, such as a parallel port, game port, or a universal serial bus (USB). A monitor 191 or other type of display device is also connected to the system bus 121 via an interface, such as a video interface 190. The monitor 191 may also be integrated with a touch-screen panel or the like. Note that the monitor 191 and/or touch-screen panel can be physically coupled to a housing in which the computer 111 is incorporated, such as in a tablet-type personal computer. In addition, computing devices such as the computer 111 may also include other peripheral output devices such as speakers 195 and a printer 196, which may be connected through an output peripheral interface 194 or the like.

The computer 111 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 111, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprisewide computer networks, intranets, and the Internet. For example, in the present facility, the computer 111 may comprise the source machine from which data is being migrated, and the remote computer 180 may comprise the destination machine. Note, however, that source and destination machines need not be connected by a network or any other means, but instead, data may be migrated via any media capable of being written by the source platform and read by the destination platform or platforms.

When used in a LAN networking environment, the computer 111 is connected to the LAN 171 through a network interface or adapter 170. When used in a WAN networking environment, the computer 111 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 111, or portions thereof, may be stored in the remote memory storage device 181. By way of example, and not limitation, FIG. 1 illustrates remote application programs 185 as residing on the memory storage device 181. It will be appreciated that the network connections shown are exemplary and other means of establishing a communications link between the computers may be used.

While various functionalities and data are shown in FIG. 1 as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

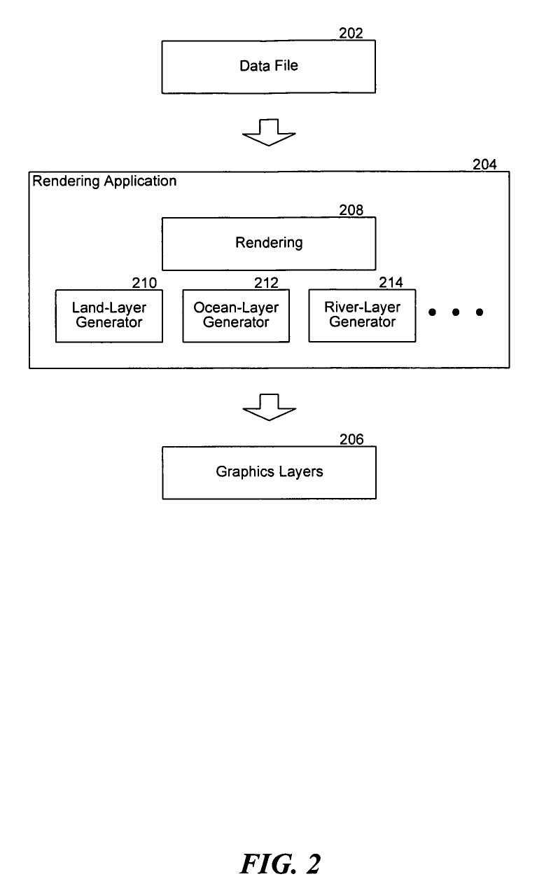

FIG. 2 is a block diagram illustrating aspects of the facility in various embodiments. The facility receives a data file 202 that defines objects that are to be rendered. Data files can provide inputs of locations for objects that are to be rendered, such as by identifying one or more “control points.” A control point identifies a point corresponding to an object, such as the object's center. As a specific example, data files for maps generally define various geometric parameters for map features, such as rivers, mountains, coastlines, mountains, settlements, and so forth. The facility can employ data files of various formats, such as text files, extensible markup language (“XML”) files, binary files, and so forth. The data file further provides labels associated with each object the data file defines. As an example, the data file may define some lines as rivers and other lines as mountain ranges or other features. The following provides an example of a portion of a data file in XML:

...
<polyline type=“river” points=“120 30, 25 150, 290 150” />
<polyline type=“mountain” points=“220 45, 240 65, 260 55, 280 65” />
...

This example indicates that a river is defined using the X,Y coordinates of (120,30), (25,150), and (290,150). A line segment from each of these coordinates to the next coordinate defines the river.

In various embodiments, the facility may receive the label information from a source outside the data file. As an example, a user may manually indicate feature types. Alternatively, a second data file may provide a correspondence between objects and feature types. The data files can provide objects in various ways, including as vector representations.

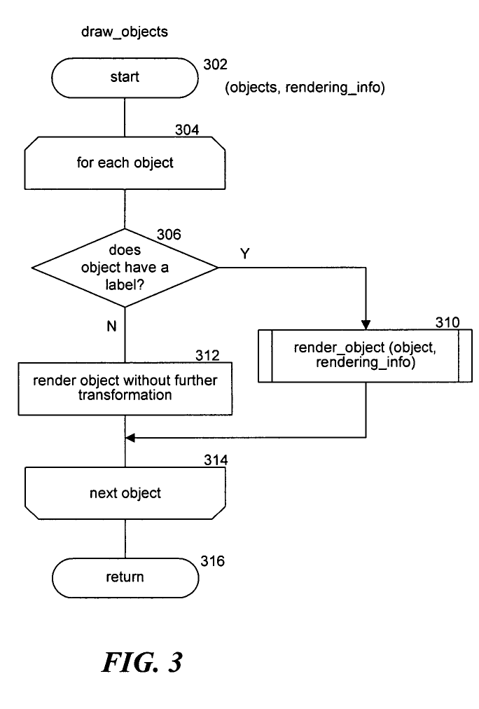

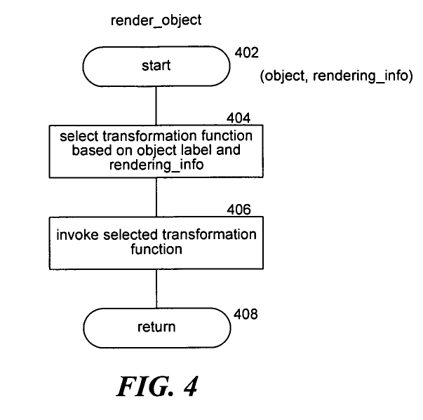

A rendering application 204 receives and processes input, such as from a data file, to output a set of one or more graphics layers 206. The rendering application has a rendering object 208. The rendering object processes objects defined by the data file. This rendering object invokes draw_objects and render_object routines to transform and render each object. These routines are described in further detail below in relation to FIGS. 3 and 4, respectively.

The rendering application may load various layer generator objects, such as from a dynamic link library (“DLL”) corresponding to the style in which the object is to be rendered. The illustrated embodiment functions with maps. Accordingly, the rendering application is shown as having loaded generators for map features, including a land-layer generator 210, ocean-layer generator 212, and river-layer generator 214. For each object in the data file, the rendering object determines which of the generator objects is to render the object. In various embodiments, each of the generator objects may provide one or more transformation functions corresponding to a particular feature. As an example, the land-layer generator object may provide a transformation function for mountain ranges and another transformation function for coastlines. The facility may function with multiple generator objects, such as a set of generator objects for the woodcut style and another set of generator objects for the animation style.

The rendering application may load multiple sets of generator objects. As an example, the facility may have sets of generator objects that each provide a different style, such as woodcut, animation, and so forth.

The transformation functions each add one or more layers to graphics layers 206 when they transform and render an object. These graphics layers combine to produce an image representing the objects. The transformation functions may be associated with various types of objects and provide: point features such as trees, houses, etc.; linear features such as streets, rivers, etc.; area features such as lakes, land masses, etc.; and volumetric features such as buildings, volcanoes, etc.

In various embodiments, the transformation functions are “procedural,” in that an algorithm is used to render an object instead of transforming an existing bitmap. In other embodiments, the transformation functions may transform images or bitmaps to render objects. Transformation functions transform vector representation into graphical form, and as such may involve parameters that adjust color, geometry, drawing style, degree of blur, and other visual components of the rendered image. In yet other embodiments, the transformation functions may use hybrid approaches.

In various embodiments, the facility may use various additional properties to further manipulate rendered images. As an example, the facility may receive an indication of a time of day or day of year from a user and render scenes appropriately. As an example, shadows may appear on an appropriate side and backgrounds may be appropriately colored.

FIG. 3 is a flow diagram illustrating a draw_objects routine executed by the facility in various embodiments. The rendering object may perform the routine. The routine begins at block 302 where it receives a set of objects and rendering information as parameters. As an example, the routine may receive objects from a data file and the rendering information from the data file or from user input. Examples of rendering information include, e.g., artistic effects, such as the woodcut style of maps.

Between blocks 304 and 314, the routine processes each object in the set of objects. At block 304, the routine selects an object from the received set of objects.

At block 306, the routine determines whether the selected object has a label. A label indicates the type of an object, such as a map's feature. When the object has a label, the facility is able to invoke a routine to render the indicated type of object, such as a routine that performs a transformation based on the object's type. When the object has a label, the routine continues at block 310. Otherwise, the routine continues at block 312 to render the object without any transformation that is specific to the type of object.

At block 310, the routine invokes a render_object subroutine to render the selected object. The render_object subroutine is described in further detail below in relation to FIG. 4. In various embodiments, the routine may provide an indication of the object and the received rendering information as parameters to the render_object subroutine.

At block 312, the routine renders the selected object. When the routine renders the selected object, the routine may add a bitmapped image to the graphics layers 206 corresponding to the selected object. As an example, the routine may draw a tree or other shape for a point feature that is labeled as “tree”.

At block 314, the routine selects another object that has not yet been processed. When all objects have been processed, the routine continues at block 316, where it returns. Otherwise, the routine continues at block 306.

In various embodiments, the facility performs further geometric transformations to the rendered objects, such as to add perspective effects. In various embodiments, this geometric transformation is performed by the transformation functions.

FIG. 4 is a flow diagram illustrating a render-object routine executed by the facility in various embodiments. The draw_objects routine described above in relation to FIG. 3 may invoke the routine to select a transformation function provided by one of the generator objects. The routine begins at block 402 where it receives indications of an object and rendering information as parameters.

At block 404, the routine selects a transformation function based on the object's label and the rendering information. As an example, if the label indicates that the object is a river, the routine selects a river transformation function provided by a river-layer generator. If the label indicates that the object is a mountain range, the routine selects a mountain range transformation function provided by the land-layer generator. Generator objects can provide multiple transformation functions. As an example, the land-layer generator object may provide transformation functions for coastlines, mountain ranges, and other land-related rendering transformations. The routine selects a set of generator objects based on the received rendering information. As an example, the routine selects a set of generator objects that provide a woodcut style when the rendering information indicates the woodcut style. The generator objects may have additional parameters which may be adjusted automatically or manually by the user to account for other effects, e.g., perspective effects or color effects.

At block 406, the routine invokes the selected transformation function. As an example, the routine may invoke the mountain range transformation function of the land-layer generator that provides the woodcut style. The routine provides an indication of the object to the transformation function. As an example, the routine may provide the control points and other information associated with the object that is to be rendered. The transformation function renders the object and adds the rendered object to the graphics layers.

At block 408, the routine returns.

In various embodiments, the facility may perform various artistic projections, such as to shift a tree that occludes a more important feature, such as a house.

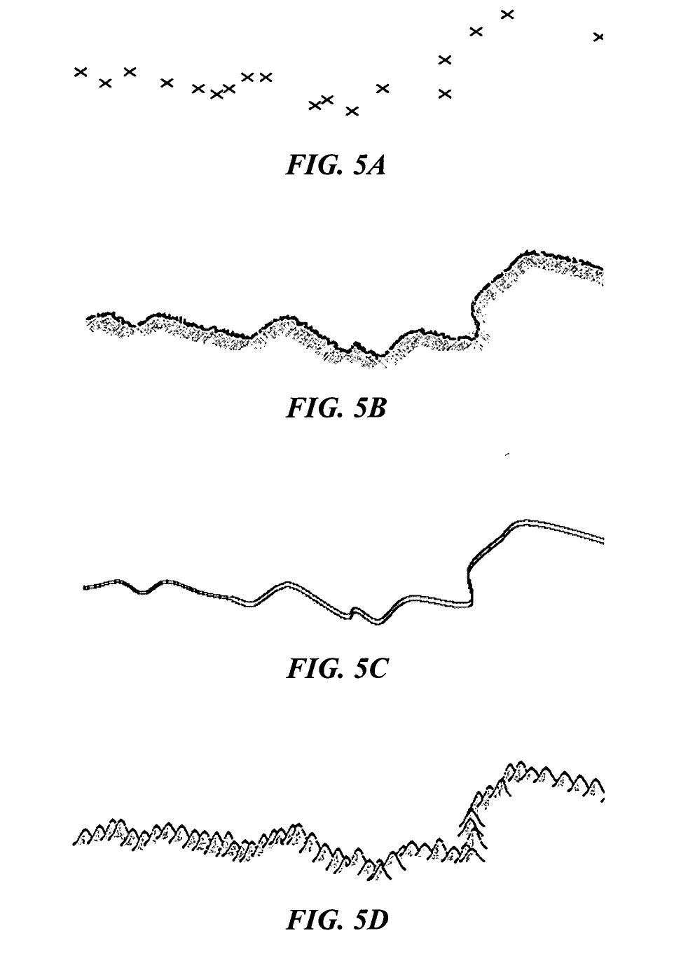

FIG. 5A is a display diagram illustrating an example of a line object defined by multiple control points. The illustrated set of control points define a line that is assembled from a set of line segments that each terminate at two consecutive control points.

FIGS. 5B-5D are display diagrams illustrating potential map features and rendering styles corresponding to the line object of FIG. 5A. FIG. 5B illustrates a coastline. A transformation function may transform the line object into the coastline when a label associated with the control points of FIG. 5A indicates a coastline. FIG. 5C illustrates a river. A transformation function may transform the line object into the river when a label associated with the control points of FIG. 5A indicates a river. This transformation function may assume that one end of the river (e.g., the first or last control point) is the river's source and may widen the rendering of the river as it progresses from the source. FIG. 5D illustrates a mountain range. A transformation function may transform the line object into the mountain range when a label associated with the control points of FIG. 5A indicates a mountain range. Thus, as can be seen, the facility can render a set of control points into various features by using various transformation functions that are associated with labels identifying the type of features. In various embodiments, the facility may employ a randomness factor provided by a user to introduce stochastic randomness, e.g., to control the wiggles in a river.

In various embodiments, the facility enables a user to select styles for various objects manually. As an example, when drawing a city map using an artistic rendering style, the user may specify that a landmark building is to be rendered in a historic style whereas a newer building is to be rendered in a more modern style. The facility could then use the appropriate transformation functions.

In various embodiments, a user can select a color choice, add features that do not appear in the data file, zoom to various levels, and so forth. As an example, a user may be able to identify and add a particular location on a map, such as the user's house or office. The facility could then additionally render the user's input using the same or different style as the style used for the image or map.

In various embodiments, a user can prioritize features to illustrate, such as when multiple features occupy the same or adjacent spaces. In a further refinement, the user may be able to indicate that only streets between two locations are to be displayed, such as from the nearest freeway to the user's house.

In various embodiments, a user can specify a property relating to detail. As an example, the facility may render a small number of trees to represent a forest or may render a small number of buildings to represent a settlement.

In various embodiments, the facility can output images in various known formats, such as JPEG, vector images, or any electronic graphics representation.

Those skilled in the art will appreciate that the steps shown in FIGS. 34 and discussed above may be altered in various ways. For example, the order of the steps may be rearranged, substeps may be performed in parallel, shown steps may be omitted, other steps may be included, etc.

It will be appreciated by those skilled in the art that the above-described facility may be straightforwardly adapted or extended in various ways. As an example, the facility may iteratively employ multiple transformation functions to provide various results. While the foregoing description makes reference to particular embodiments, the scope of the invention is defined solely by the claims that follow and the elements recited therein.

We claim:

1. A method performed by a computer system for semantics-guided non-photorealistic rendering of images, comprising:
receiving a set of objects that are to be rendered in a non-photorealistic manner;
for each received object, determining whether the object has an associated indication of a feature type; and
when the object has an associated indication of a feature type, employing a transformation function corresponding to the indicated feature type to render the object in a non-photorealistic style provided by the transformation function.

2. The method of claim 1 wherein the objects are defined in a data file.

3. The method of claim 1 wherein the objects are defined in a vector format.

4. The method of claim 1 wherein the associated indication is a label.

5. The method of claim 4 wherein the label appears in an input file defining the objects.

6. The method of claim 1 wherein the associated indication is received from a user.

7. The method of claim 1 further comprising rendering the object in the style and adding the rendered object to a graphics layer.

8. The method of claim 1 wherein the rendering is performed procedurally.

9. The method of claim 8 wherein the object is rendered with stochastic variations.

10. The method of claim 1 wherein the rendering is performed by transforming an image.

11. A computer-readable medium having computer-executable instructions that perform a method for semantics-guided non-photorealistic rendering of a set of objects, the method comprising:
for each object in the set of objects, determining whether the object is indicated to be associated with an object type; and
when the object is indicated to be associated with an object type,
identifying a transformation function corresponding to the indicated object type; and
invoking the transformation function to render the object in a non-photorealistic style provided by the transformation function.

12. The computer-readable medium of claim 11 wherein the indication is a label identifying the object type, the label appearing in an input defining the set of objects.

13. The computer-readable medium of claim 11 further comprising:
rendering the object in the non-photorealistic style provided by the transformation function to render the object; and
adding the rendered object to a graphics layer.

14. The computer-readable medium of claim 11 further comprising identifying a generator component that provides the transformation function.

15. The computer-readable medium of claim 11 wherein the object is defined by an input file comprising at least control points and labels identifying a type of the object.

16. A system for semantics-guided non-photorealistic rendering of an image representing a set of objects, comprising:
a set of generator components that each generate a graphics layer for an object type; and
a rendering component that determines whether an object has an associated type and invokes a function provided by one of the generator components to render a non-photorealistic graphics layer corresponding to the object.

17. The system of claim 16 further comprising an input data file comprising at least objects and labels associated with the objects, the labels for identifying object types.

18. The system of claim 17 wherein the rendering component determines whether an object has an associated type by evaluating a label associated with the object.

19. The system of claim 18 wherein the generator component is identified in rendering information received by the rendering component.

20. The system of claim 18 wherein style information is identified in rendering information received by the rendering component and the rendering component identifies a generator component based on the received style information.
